(19) United States
(12) Patent Application Publication
(10) Pub. No.: US 2012/0045746 A1
(43) Pub. Date: Feb. 23, 2012

(54) ELECTRONIC CLASS SYSTEM

(75) Inventors: Young Hee LEE, Seoul (KR); Bo Ra KIM, Seoul (KR); Yun Hye JUNG, Seoul (KR); Hye Young YANG, Seongnam-si (KR)

(73) Assignee: TSTUDY CO., LTD., Seoul (KR)

(21) Appl. No.: 12/960,860

(22) Filed: Dec. 6, 2010

(30) Foreign Application Priority Data
Aug. 23, 2010 (KR) 10-2010-0081392

(51) Int. Cl. G09B 25/00

(52) U.S. Cl. 434/365

(57) ABSTRACT

Disclosed is an electronic class system which enables a digitalized class, wherein breaking from a conventional class method or an examination method using paper teaching materials for class and a blackboard for writing class contents, the digitalized class uses an electronic pen which is a digitalized writing tool for generating writing data, a computer which communicates with the electronic pen to receive the writing data generated by the electronic pen, and a smart board which serves as a blackboard on which the writing data received by the computer is projected as beams.

### CROSS-REFERENCE TO RELATED APPLICATION

This application claims priority from and the benefit of Korean Patent Application No. 10-2010-0081392, filed on Aug. 23, 2010, which is hereby incorporated by reference for all purposes as if fully set forth herein.

### BACKGROUND OF THE INVENTION

1. Field of the Invention

The present invention relates to an electronic class system. More particularly, the present invention relates to an electronic class system which enables a digitalized class, wherein breaking from a conventional class method or an examination method using paper teaching materials for class and a blackboard for writing class contents, the digitalized class uses an electronic pen which is a digitalized writing tool for generating writing data, a computer which communicates with the electronic pen to receive the writing data generated by the electronic pen, and a smart board which serves as a blackboard, on which the writing data received by the computer is projected as beams.

2. Description of the Prior Art

Despite abrupt development of communication technologies and electronic appliances, a class is still performed in such a manner that a teacher gives a lecture while writing class contents on a blackboard, and one or more students take a lesson while seeing the contents written on the blackboard and a paper teaching material for class and executing writing on the paper teaching material for class or a notebook with a writing tool, such as a pencil, simultaneously with listening to the lecture. In such a conventional class method, in order for the teacher or all of the students to see the contents written by any one of the students or the teacher, the corresponding contents should be written on the blackboard.

In a conventional examination method, examination papers with written examination questions should be distributed to students, and the students should submit the examination papers after writing answers to the questions on the examination papers.

### SUMMARY OF THE INVENTION

Accordingly, the present invention has been made to solve the above-mentioned problems occurring in the prior art, and an object of the present invention is to provide an electronic class system which enables a digitalized class, wherein breaking from a conventional class method or examination method using paper teaching materials for class and a blackboard for writing class contents, the digitalized class uses one or more electronic pens, each of which is a digitalized writing tool for generating writing data, a computer communicating with the electronic pens to receive the writing data (student writing data or lecturer writing data) generated by the electronic pens, and a smart board which serves as a blackboard on which the writing data (student writing data or lecturer writing data) received by the computer is projects as beams.

Another object of the present invention is to provide an electronic class system which allows contents written by a teacher or a student to be automatically displayed on a smart board if the teacher or the student writes the contents using an electronic pen, without the necessity of writing the contents on a blackboard so as to allow all of the students or the teacher to see the contents written by the teacher or the student.

Another object of the present invention is to provide an electronic class system capable of automatically transmitting answers to examination questions to a teacher's computer when a student writes the answers using an electronic pen, even if the student does not submit an examination paper with the answers written by the student.

In order to accomplish these objects, there is provided an electronic class system including: a dot book printed with a dot pattern, on which class contents or examination questions are described; a student electronic pen which generates and transmits student writing data by recognizing the dot pattern at the points where the student electronic pen comes into contact with the dot book according to student writing on the dot book; a computer which receives and outputs the student writing data through a beam projector interface; a beam projector which receives the student writing data outputted through the beam projector interface, and projects the student writing data as beams; and a smart board, on which the contents written by the student are displayed by the beams projected by the beam projector.

In accordance with another aspect of the present invention, there is provided an electronic class system including: a student electronic pen which generates and transmits student writing data by recognizing a dot pattern at the points where the student electronic pen comes into contact with a dot book printed with the dot pattern according to student writing on the dot book; a computer which receives and renders the student writing data to be projected as beams through a beam projector interface; and a smart board, on which the contents written by the student are displayed by the beams projected by the beam projector.

In accordance with another aspect of the present invention, there is provided an electronic class system including: a student electronic pen which generates and transmits student writing data by recognizing a dot pattern at the points where the student electronic pen comes into contact with a dot book printed with the dot pattern according to student writing on the dot book; a computer which receives and outputs the student writing data through a beam projector interface; a beam projector which receives the student writing data outputted through the beam projector interface, and projects the student writing data as beams; and a smart board, on which the contents written by the student are displayed by the beams projected by the beam projector.

As described above, according to the present invention, it is possible to provide an electronic class system which enables a digitalized class, wherein breaking from a conventional class method or examination method using paper teaching materials for class and a blackboard for writing class contents, the digitalized class uses one or more electronic pens, each of which is a digitalized writing tool for generating writing data, a computer communicating with the electronic pens so as to receive the writing data (student writing data or lecturer writing data) generated by the electronic pens, and a smart board which serves as a blackboard on which the writing data (student writing data or lecturer writing data) received by the computer is projected as beams.

According to the present invention, it is also possible to provide an electronic class system which allows contents written by a teacher or a student to be automatically displayed on a smart board if the teacher or the student writes the contents using an electronic pen, without the necessity of writing the contents on a blackboard so as to allow all of the students or the teacher to see the contents written by the teacher or the student.

According to the present invention, it is also possible to provide an electronic class system capable of automatically transmitting answers to examination questions to a teacher's computer when a student writes the answers using an electronic pen, even if the student does not submit an examination paper with the answers written by the student.

### BRIEF DESCRIPTION OF THE DRAWINGS

The above and other objects, features and advantages of the present invention will be more apparent from the following detailed description taken in conjunction with the accompanying drawings, in which:

FIG. 1 shows an electronic class system in accordance with an embodiment of the present invention;

FIG. 2 shows an example of transmitting student writing data so as to display student writing on a smart board, wherein the student writing is executed on a dot book using a student electronic pen in the inventive electronic class system;

FIG. 3 shows an example of transmitting lecturer writing data so as to display lecturer writing on a smart board, wherein the lecturer writing is executed using at least one of a lecturer electronic pen, a tablet device, and a computer (tablet computer) in the inventive electronic class system;

FIG. 4 shows an example of transmitting lecturer writing data corresponding to lecturer writing contents directly written on a smart board by a lecturer using a smart board electronic pen in the inventive electronic class system; and

FIG. 5 shows a smart board printed with a dot pattern in an electronic class system in accordance with an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

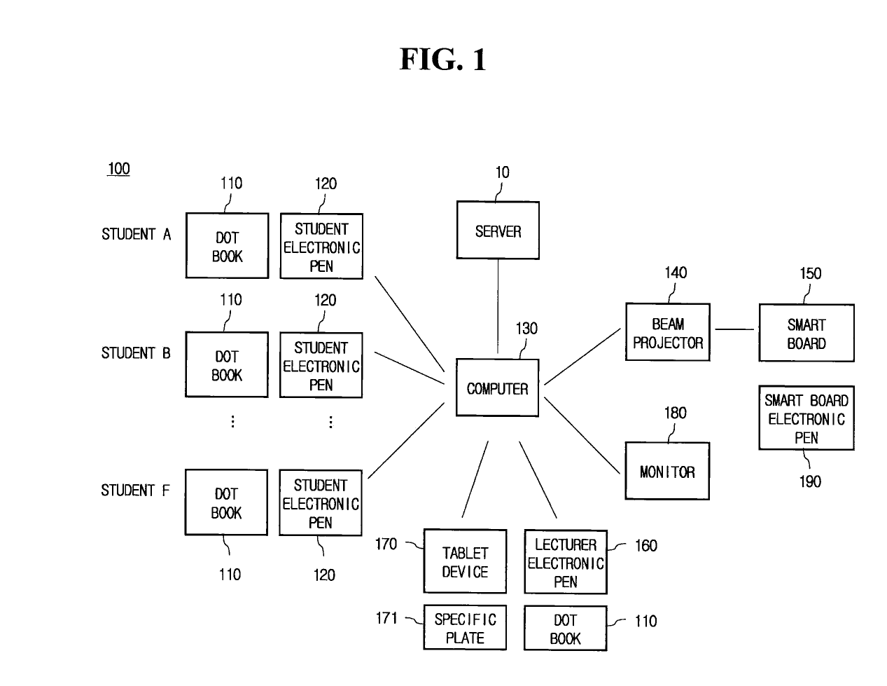

FIG. 1 shows an electronic class system 100 in accordance with an embodiment of the present invention.

As shown in FIG. 1, the electronic class system 100 in accordance with an embodiment of the present invention includes: a dot book 110 and a student electronic pen 120 which are provided as in a pair for each of students (student A, student B, . . . , student F); a computer 130 communicating with each of the student electronic pens 120 in a predetermined communication mode so as to receive student writing data; a beam projector 140 receiving student writing data from the computer 130 and projecting the student writing data as beams; and a smart board 150, on which the beams projected by the beam projector 140 are imaged.

A dot book 110 and a student electronic pen 120 are the pair of class tools used by one student for taking a lesson or taking an examination.

The dot book 110, which is one of a pair of class tools, is a digital type learning material which is printed with a dot pattern recognizable by the student electronic pen 120, and has class contents or examination questions written on the printed dot pattern.

The student electronic pen 120, which is the other of the pair of class tools, generates student writing data by recognizing the dot pattern at the points where it comes into contact with the dot book 110 in accordance with student writing on the dot book 110, and transmits the generated student writing data to the computer 130. That is, if a student executes writing on his/her dot book 110 with his/her own student electronic pen 120, the student electronic pen 120 can recognize the dot pattern at the points where it comes into contact with the dot book 110, and can generate student writing data corresponding to the student writing on the basis of recognized information (e.g., coordinate values of dots (position information) or the like included in the dot pattern).

The above-mentioned student electronic pen 120 stores information for the dot pattern printed on the dot book 100, wherein the student electronic pen 120 can recognize the dot pattern at the points where the student electronic pen 120 come into contact with the dot book 110 using a camera or a scanner with reference to the stored information for the dot pattern (e.g., the coordinate values of the dots or the like), and can generate the student writing data by determining the traces of the student writing.

The above-mentioned computer 130 communicates with the student electronic pen 120 of each student, and receives student writing data from the student electronic pen 120, and outputs the received student writing data through a beam projector interface so that the student writing executed by the student electronic pen 120 can be displayed on the smart board.

On the basis of the student writing data received from the student electronic pen 120, the computer 130 can generate output data to be outputted to the beam projector interface (or monitor interface) using a program for configuring an output screen. For example, if plural student writing data were received from plural student electronic pens 120, the computer 130 can generate an output data which divides the entire output screen into plural sub-screens so that each of the sub-screens can display student writing corresponding to one student writing data.

As a result, the beam projector 140 receives student writing data outputted through the beam projector interface of the computer, and projects the student writing data onto the smart board 150 as beams. On the smart board 150, student writing is displayed by the beams projected by the beam projector 140. The monitor of the computer 130 displays a screen equal to the screen displayed on the smart board by the beams projected from the beam projector 140.

Referring to FIG. 1, the inventive electronic class system 100 may further include at least one of a lecturer electronic pen 160 and a tablet device 170, wherein the lecturer electronic pen 160 recognizes lecturer writing data by recognizing the dot pattern at the points where the lecturer electronic pen 160 comes into contact with the dot book 110 in accordance with lecturer writing on the dot book 110, and generates and transmits lecturer writing data to the computer 130, and wherein the tablet device 170 recognizes the dot pattern at the points where it comes into contact with the dot book 110 or a specific plate 171 in accordance with lecturer writing on the dot book 110 or the specific plate 171.

If the lecturer electronic pen 160 and/or the tablet device 170 are used, the contents to be explained can be displayed on the smart board 150 by the lecturer (teacher).

For this purpose, the computer 130 outputs at least one of lecturer writing data from the lecturer electronic pen 160 and lecturer writing data generated using the dot pattern recognized by the tablet device 170 through the beam projector interface, the beam projector 140 receives the lecturer writing data outputted through the beam projector interface of the computer, and projects the lecturer writing data as beams, and the lecturer writing is displayed on the smart board by the beams projected from the beam projector 140.

In order to display the contents to be explained or the like on the smart board 150, the lecturer may use the computer 130, besides the lecturer electronic pen 160 and/or the tablet device 170. In such a case, the computer 130 should be a tablet computer including a touch screen on which the dot pattern is printed. As such, the computer 130 generates lecturer writing data by recognizing the dot pattern at the points touched in accordance with the lecturer writing on the touch screen, and outputs the generated lecturer writing data through the beam projector interface, the beam projector 140 receives the lecturer writing data outputted through the beam projector interface of the computer 130, and projects the lecturer writing data as beams, and the lecturer writing is displayed on the smart board 150 by the beams projected by the beam projector 140.

Referring to FIG. 1, the inventive electronic class system 100 is adapted to be capable of displaying at least one of student writing and lecturer writing not only through the beam projector 140, but also on a monitor 180 of a television set or the like. For this purpose, as shown in FIG. 1, the inventive electronic class system 100 may further include a monitor 180 which can display at least one of student writing data received from one or more student electronic pens 120 by the computer 130, and lecturer writing data generated by at least one of the lecturer electronic pen 160, the tablet device 170 and the computer, by receiving them through the monitor interface.

As described above, the smart board 150 displays student writing corresponding to student writing data generated by other devices (including at least one of a student electronic pen 120, a computer 130, a lecturer electronic pen 160, and a tablet device 170) and/or lecturer writing corresponding to lecturer writing data by a beam projection mode. Besides this function, the lecturer writing may be executed on the smart board 150 by a lecturer, and may be recognized by a smart board electronic pen 190. For this purpose, a dot pattern may be printed on the smart board 150.

If the dot pattern is printed on the smart board 150 like this, the inventive electronic class system 100 may further include a smart board electronic pen 190 which generates lecturer writing data by recognizing the dot pattern at the points where it comes into contact with the smart board 150, and transmits the generated lecturer writing data to the computer 130.

In such a case, the computer 130 may output the lecturer writing data received from the smart board electronic pen 190 to a beam projector interface or a monitor interface.

In addition, the above-mentioned smart board electronic pen 190 may recognize the dot pattern at the points where the smart board electronic pen 190 comes into contact with a specific part displayed on the smart board by the beams projected from the beam projector 140. In such a case, the smart board electronic pen 190 may conduct a process corresponding to the specific part or transmit the recognized information of the specific part to the computer 130. Upon receiving the recognized information of the specific part from the smart board electronic pen 190, the computer 130 can conduct the process corresponding to the specific part. For example, the smart board electronic pen 190 or the computer 130 can recognize the text contents written in the specific part, and conduct a process for at least one of a dictionary function or a voice output function for the recognized text contents. As a result, like the case in which a user selects a specific icon shown on the monitor of the computer so as to implement the corresponding function while seeing the computer monitor, the user can select the specific part displayed on the smart board 150 while seeing the smart board 150, so that the corresponding function can be implemented by the smart board electronic pen 190 or the computer 130.

The smart board electronic pen 190 stores information for the dot pattern printed on the smart board 150, wherein the smart board electronic pen 190 can recognize the dot pattern at the points where it comes into contact with the smart board 150 using a camera or a scanner with reference to the stored information for the dot pattern (e.g., coordinate values of dots), and can generate lecturer writing data by determining the traces of the lecturer writing on the basis of the recognized information (e.g., coordinate values of dots).

Electronic pens, including the above-mentioned student electronic pen 120, lecturer electronic pen 160, and the smart board electronic pen 190, and the computer 130 may communicate with each other on the basis of wired or wireless communication. In the case of wired-based communication, the electronic pens and the computer 130 may communicate with each other via a wired communication network or by being directly interconnected with each other by cable lines. In the case of wireless-based communication, the electronic pens and the computer 130 may communicate with each other by being interconnected with each other through APs (Access Points), or a Bluetooth or infrared system without such an AP.

The student electronic pen 120 recognizes the dot pattern at the points where it comes into contact with the dot book 110, thereby acquiring the position information items of the recognized dot pattern (e.g., coordinate values of the dots or the like), wherein the student electronic pen 120 can generate student writing data including the acquired position information items, student writing data including writing trace data in accordance with the acquired position information items, or student writing data including a writing trace image in accordance with the acquired position information items. In the same manner, the lecturer electronic pen 160 and the smart board electronic pen 190 can generate lecturer writing data. In addition, the computer 130 may receive position information items of the points where the tablet device 170 and the specific plate 171 come into contact with an electronic pen from the tablet device 170 or a tablet function module of the computer 130, and generate lecturer writing data in the same manner with the generation of the student writing data.

The above-mentioned computer 130 may store the student writing data received through the student electronic pen 120, and/or the lecturer writing data received through the lecturer electronic pen 160 and the smart board electronic pen 190. The computer 130 may store (record) the lecture contents, class results for a corresponding student, and writing contents of the student and/or lecturer using the transmitted/received data, and may upload the stored data onto a server with internet access so that the stored data can be used in an online class or the like.

When examination questions are written on the dot book 110, the above-mentioned computer 130 may receive student writing data through the student electronic pen 120 as answers to the examination questions, and may store or output scoring result data or answer analysis data based on the student writing data to the beam projector interface or monitor interface.

All of the above-mentioned student electronic pen 120, lecturer pen 160 and smart board electronic pen 190 have the same function, except the users and uses thereof. However, the implemented forms and shapes thereof may be different from each other.

In connection with the electronic class system 100 in accordance with an embodiment of the present invention, the data flow of student writing data and lecturer writing data in the electronic class system 100 will be discussed below.

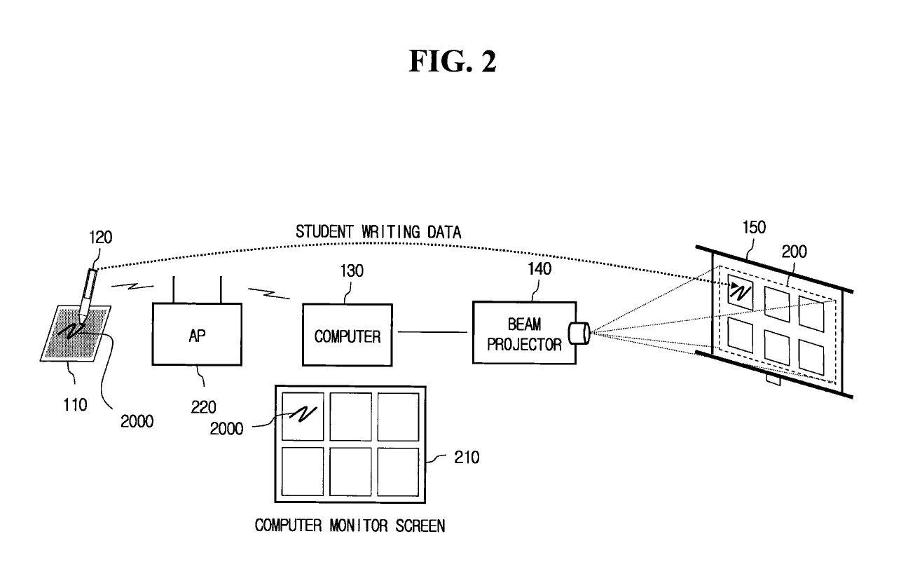

FIG. 2 shows an example of transmitting student writing data so as to display, on the smart board 150, student writing executed by a student on the dot book 110 in the inventive electronic system.

FIG. 2 is an example of transmitting student writing data for writing contents (student writing) written on the dot book by Student A among plural students, using his/her own student electronic pen 120, wherein it is assumed that the student electronic pen 120 and the computer 130 communicate with each other through an AP 220 with a wireless communication mode.

Referring to FIG. 2, if Student A writes contents 2000 on the dot book 110 with his/her own student electronic pen 120, the student electronic pen 120 recognizes the dot pattern at the points where it comes into contact with the dot book 110, and generates student writing data on the basis of the recognized dot pattern. The student electronic pen 120 transmits the student writing data generated in this manner to the computer 130 through the AP 220.

Referring to FIG. 2, the computer 130 generates an output data to be outputted to the beam projector 140 (or monitor 180) using a program for configuring an output screen, so as to display the writing contents 2000 of Student A on the basis of the student writing data received from the student electronic pen 120 of Student A. At this time, the output data may be generated by using the student writing data of any other student together with the student writing data of Student A. A program for configuring an output screen may divide the entire screen into a plurality of sub-screens, the number of which corresponds to the number of the students, so that each sub-screen displays student writing contents according to the student writing data of one corresponding student.

Referring to FIG. 2, the computer projects the output data containing student writing data concerned with Student A to the smart board 150 as beams through the beam projector 140, so that the writing contents 2000 of Student A are displayed on the corresponding sub-screen. On the screen 200 projected to the smart board in this manner, student writing contents according to the student writing data of all of the students (Student A, Student B, Student C, Student D, Student E, Student F) may be displayed separately from student to student.

In addition, the computer 130 may also output the output data containing the student writing data concerned with Student A on the screen 210 of the computer monitor or the monitor 180 of a television set or the like in the same manner, so that the writing contents 2000 of Student A configured in the screen 210 can be displayed on the corresponding sub-screen.

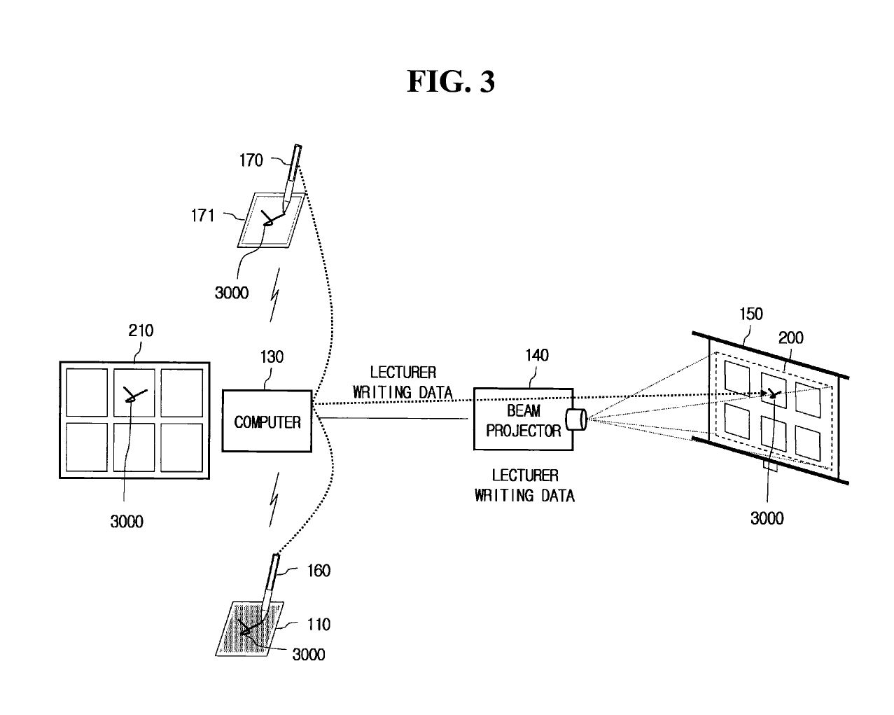

In the above, it has been described with reference to FIG. 2 that in order to allow student writing contents written by a student using a student electronic pen 120 to be displayed on the smart board 150, student writing data is generated by the student electronic pen 120, and the generated student writing data is transmitted from the student electronic pen 120 to the beam projector through the computer 130. Now, concerning a case in which a lecturer writes class contents or solutions to questions as lecturer writing contents using a lecturer electronic pen 160, a tablet device 170 or a computer 130 which is a tablet computer, description will be made as to an example of transmitting the lecturer writing data so that the lecturer writing contents can be displayed on the smart board 150 with reference to FIG. 3.

When an OMR (Optical Mark Reader) card printed with a dot pattern which allows answers to multiple choice questions to be checked using a student electronic pen 120 is used instead of the dot book 110, the student electronic pen 120 may confirm the answers checked on the OMR card in accordance with the dot pattern recognition method so as to generate student writing data containing answer check information, and may transmit the student writing data containing the answer check information to the computer 130.

After receiving the student writing data containing the answer check information, the computer 130 may project the answer check information contained in the student writing data to the smart board 150 so that the answer check information can be displayed, or may not project the answer check information contained in the student writing data to the smart board 150 for the purpose of preventing students' misuse of answer check information or protecting students' privacy.

The computer 130 may perform scoring through an automatic scoring module using the answer check information contained in the received student writing data and may store the results. In addition, the computer 130 may collect and statistically process the scoring results of respective students, thereby generating various statistic and analysis data, such as the percentages of correct answers and incorrect answers, which may be stored in the computer 130 or may be projected to the smart board 150 to be displayed.

In addition, the computer 130 may analyze the scoring results of a corresponding student, and may store the strength and vulnerabilities of the student and learning proposal information according to the analysis together with the scoring results, so that the computer 130 can transmit them to the email or computer of the corresponding student as required.

According to the embodiment described just before, it is possible to perform the analysis of scoring results and the feedback of incorrect answers directly after the termination of test using an OMR card. As a result, the processes of testing, scoring, analysis of results, and feedback in a conventional testing method can be rapidly executed in class, which can further enhance learning effects for a test.

In addition, according to the inventive electronic class system 100, it is possible for each student to compare his/her answers or solving procedures with those of other students in class through a test using an OMR card and an electronic pen 120, or an essay or short-answer test. As a result, more efficient learning can be accomplished since students can share their thought processes. For this purpose, the above-mentioned computer 130 may collect student writing data containing test answers generated using OMR cards and electronic pens 120, or essay-answer test answers or short-answer test answers generated using the dot book 110 and the electronic pens 120, so that students can share various thought processes thereof on the basis of the collected student writing data through an application for a data comparing mode.

FIG. 3 shows an example of transmitting lecturer writing data so as to display lecturer writing contents on the smart board 150, wherein the lecturer writing contents are written by a lecturer using at least one of a lecturer electronic pen 160, a tablet device 170, and a computer 130 in the inventive electronic class system 100.

Referring to FIG. 3, the lecturer can write lecturer writing contents 3000 using at least one of a lecturer electronic pen 160, a tablet device 170 and a computer 130. Here, the lecturer writing contents 3000 may be written class contents, question solving contents, contents for correction or the like. In the example of FIG. 3, it is assumed that the lecturer writing contents 3000 are concerned with Student B.

The computer 130 receives lecturer writing data generated by recognizing the lecturer writing contents 3000 written by the lecturer electronic pen 160, lecturer writing data generated using the recognized information for the lecturer writing contents 3000 recognized by the tablet device 170, or lecturer writing data generated using the recognized information for the lecturer writing contents 3000 recognized through a touch screen using the tablet function of the computer receives lecturer writing data generated using the recognized information for the lecturer writing contents 3000.

The computer 130 displays the lecturer writing contents 3000 at the student note of Student B on the screen 210 of the computer monitor. Together with this, the computer 130 may generate output data and output the data to the beam projector so that the lecturer writing contents 3000 corresponding to the received lecturer writing data can be displayed on the smart board 150. At this time, it is possible to control the lecturer writing contents corresponding to the received lecturer writing data in such a manner that the contents can be displayed on the sub-screen (student note) of Student B on the screen 200 formed by projecting beams on the smart board 150. Of course, it is also possible to control the lecturer writing contents 3000 in such a manner that the contents can be displayed on the entirety of the screen 200 of the smart board 150.

In addition, the computer 150 may generate a single output data by putting the received lecturer writing data together with student writing data received from the student electronic pen 120, and may output the output data to the beam projector 140.

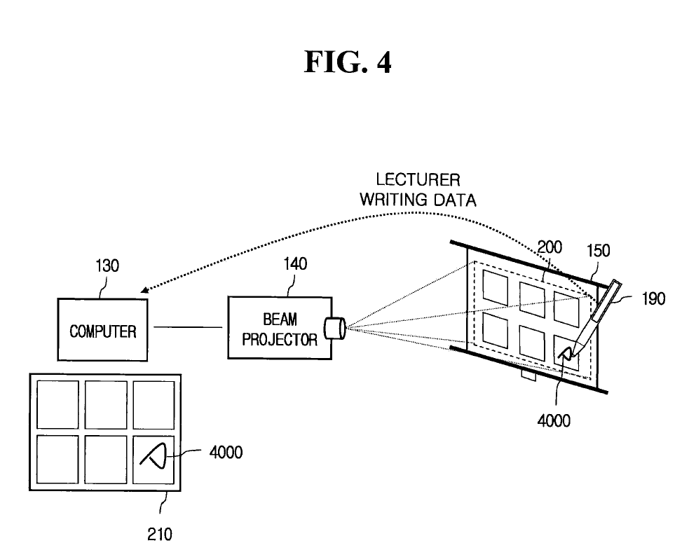

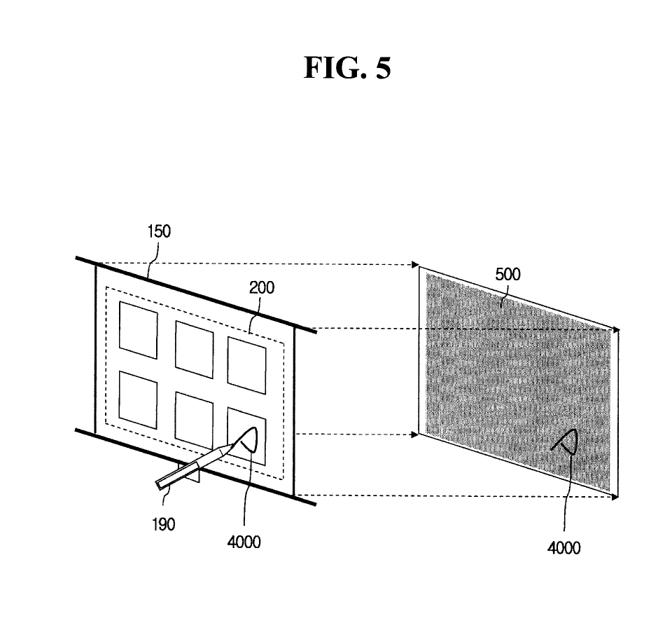

Examples of transmitting student writing data and lecturer writing data so as to display student writing contents and lecturer writing contents on the smart board were described above. Now, an example of transmitting lecturer writing data for lecturer writing contents directly written on the smart board 150 by a lecturer using a smart board electronic pen 190 will be described with reference to FIGS. 4 and 5.

FIG. 4 shows an example of transmitting lecturer writing data for lecturer writing contents 4000 directly written on the smart board 150 by a lecturer using a smart board electronic pen 190 in the inventive electronic class system 100. However, it is assumed that the lecturer writes the lecturer writing contents 4000 on the student note of Student F on the screen 200 of the smart board 150.

In order to transmit the lecturer writing data for the lecturer writing contents 4000 written on the smart board 150 by the lecturer using the smart board electronic pen 190 in this manner, a dot pattern 500 should be printed on the smart board 150 in advance as shown in FIG. 5.

If the lecturer writes the lecturer writing contents 4000 directly on the smart board 150 using the smart board electronic pen 190, the smart board electronic pen 190 recognizes the dot pattern 500 at the points where it comes into contact with the smart board 150, thereby recognizing the lecturer writing contents 4000, wherein the smart board electronic pen 190 can generate lecture writing data on the basis of the recognized lecture writing contents 4000. The smart board electronic pen 190 can transmit the lecturer writing data generated in this manner to the computer directly or through an access point 220 with a wireless communication mode.

The computer 130 renders the corresponding lecturer writing contents 4000 to be displayed at the student note of Student F on the screen 210 of the computer monitor.

The contents displayed on the smart board 150 so as to proceed with class may include lesson contents (lecture contents) displayed by being projected through the computer 130 and the beam projector 140 as well as the lecturer writing contents 4000 directly written by the lecturer using the smart board electronic pen 190. Here, the class contents displayed by being projected to the smart board 150 may contain at least one of a teaching program content which can be commonly lectured to the entirety of students in one class, one or more teaching program contents which are variously prepared for each of the students in one class according to the grade, progress, level or the like of the students in one class, and contents of teaching materials which are tailored to respective students.

In this connection, the computer 130 may store teaching program data which can be lectured commonly to the entirety of students by a lecturer, wherein the data may be inputted by a lecturer to the computer 130 in a predetermined type or may be transmitted to the computer 130 from the server 10. The computer 130 outputs the stored teaching program data to the beam projector interface, so that the corresponding teaching program contents can be projected to the smart board 150. On the basis of the teaching program contents projected to and displayed on the smart board 150, it is possible to proceed with a class.

In addition, when students are differentiated from each other in terms of grade, progress, level or the like, the computer 130 may store one or more data which are input in a predetermined type or received from the server 10, or data for teaching materials tailored to respective students, which are input in a predetermined type or received from the server 10. The computer may output the one or more data or the data for teaching materials tailored to respective students, so that the data can be projected to the smart board 150. On the basis of the teaching program contents and the contents of teaching materials tailored to respective students, it is possible to give a class in accordance with the learning level of each of the students.

If the students recognize dot books 110, which are printed with different dot patterns, respectively, with their own student electronic pens 120 during a class, the computer 130 capable of communicating with the student electronic pens 120 may load the one or more corresponding teaching program data or the data for teaching materials tailored to respective students from an internal storage medium or the server 10, and may output the loaded data to the beam projector interface, so that the loaded data can be projected to the smart board 150.

As described above, according to the present invention, it is possible to provide an electronic class system 100 which enables a digitalized class, wherein breaking from a conventional class method or examination method using paper teaching materials for class and a blackboard for writing class contents, the digitalized class uses electronic pens 120, 160 and 190, each of which is a digitalized writing tool for generating writing data, a computer 130 communicating with the electronic pens to receive the writing data (student writing data or lecturer writing data) generated by the electronic pens, and a smart board which serves as a blackboard on which the writing data (student writing data or lecturer writing data) received by the computer 130 is projected as beams.

If the inventive electronic class system 100 is used, student writing contents 2000 and lecturer writing contents can be simultaneously written. As a result, it is possible to give an effective bidirectional active class between students and a lecturer rather than a mono-directional passive class.

According to the present invention, it is also possible to provide an electronic class system 100 which allows contents written by a teacher or a student to be automatically displayed on a smart board 150 if the teacher or the student writes the contents using an electronic pen 120, 160 or 190, without the necessity of writing the contents on a blackboard so as to allow all of the students or the teacher to see the contents written by the teacher or the student.

According to the present invention, it is also possible to provide an electronic class system 100 capable of automatically transmitting answers to examination questions to a computer 130 of a teacher when a student writes the answers using an electronic pen 120, even if the student does not submit an examination paper with the answers written by the student.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An electronic class system comprising:
a dot book printed with a dot pattern, on which class contents or examination questions are described;
a student electronic pen which generates and transmits student writing data by recognizing the dot pattern at the points where the student electronic pen comes into contact with the dot book according to student writing on the dot book;
a computer which receives and outputs the student writing data through a beam projector interface;
a beam projector which receives the student writing data outputted through the beam projector interface, and projects the student writing data as beams; and
a smart board, on which the contents written by the student are displayed by the beams projected by the beam projector.

2. The electronic class system as claimed in claim 1, wherein the monitor of the computer is displayed with a screen which is the same with a screen displayed on the smart board by the beams projected from the beam projector.

3. The electronic class system as claimed in claim 1, further comprising: at least one of a lecturer electronic pen which generates lecturer writing data by recognizing the dot pattern at the points where the lecturer electronic pen comes into contact with the dot book as a lecturer writes contents on the dot book, and which transmits the lecturer writing data to the computer; and a tablet device which recognizes the dot pattern at the points where the tablet device comes into contact with the dot book or a specific plate as the lecturer writes contents on the dot book or the specific plate,
wherein the computer outputs, through the beam projector interface, at least one of the lecturer writing data received from the lecturer electronic pen, and the lecturer writing data generated using the dot pattern recognized by the tablet device,
wherein the beam projector projects the lecturer writing data outputted through the beam projector interface, and
wherein the smart board displays the contents written by the lecturer by the beams projected by the beam projector.

4. The electronic class system as claimed in claim 1, wherein if the computer is a tablet computer having a touch screen printed with a dot pattern, the computer generates lecturer writing data by recognizing the dot pattern at the points where the touch screen is touched as the lecturer writes contents, and outputs the lecturer writing data through the beam projector interface,
the beam projector receives the lecturer writing data outputted through the beam projector interface, and projects the lecturer writing data as beams, and
the contents written by the lecturer is displayed on the smart board by the beams projected by the beam projector.

5. The electronic class system as claimed in claim 3 or 4, further comprising a display monitor which receives at least one of the student writing data received by the computer from the student electronic pen, and the lecturer writing data through a monitor interface, and displays the received data.

6. The electronic class system as claimed in claim 1, wherein if the smart board is printed with a dot pattern, the electronic class system further comprises a smart board electronic pen which generates lecturer writing data by recognizing the dot pattern at the points where the smart board electronic pen comes into contact with the smart board as a lecturer writes contents, and
wherein the computer outputs the lecturer writing data received from the smart board electronic pen to the beam projector interface or to a monitor interface.

7. The electronic class system as claimed in claim 6, wherein the smart board electronic pen recognizes the dot pattern at the points where the smart board electronic pen comes into contact with a specific part displayed on the smart board by the beams projected from the beam projector so as to conduct a process corresponding to the specific part or to transmit the recognized information of the specific part to the computer, and
the computer conducts the process corresponding to the specific part if it receives the recognized information of the specific part.

8. The electronic class system as claimed in claim 7, wherein the smart board electronic pen or the computer recognizes text contents written on the specific part, and conducts a process for at least one of a dictionary function for the recognized text and a voice output function.

9. The electronic class system as claimed in claim 1, wherein an electronic pen including the student electronic pen and the computer communicate with each other with a wireless communication mode or through an access point.

10. The electronic class system as claimed in claim 1, wherein the student electronic pen acquires position information items of the recognized dot pattern at the points where the student electronic pen comes into contact with the dot book, and
wherein the student electronic pen generates the student writing data containing the acquired position information items, generates the student writing data containing a writing trace data according to the acquired position information items, or generates a writing trace image according to the acquired position information items.

11. The electronic class system as claimed in claim 1, wherein the computer stores the student writing data received through the student electronic pen.

12. The electronic class system as claimed in claim 1, wherein if the examination questions are written on the dot book, the computer receives the student writing data as answers to the examination questions through the student electronic pen, and stores or outputs scoring result data or solution analysis data based on the student writing data to the beam projector interface or a monitor interface.

13. An electronic class system comprising:
a student electronic pen which generates and transmits student writing data by recognizing a dot pattern at the points where the student electronic pen comes into contact with a dot book printed with the dot pattern according to student writing on the dot book;
a computer which receives and renders the student writing data to be projected as beams through a beam projector interface; and
a smart board, on which the contents written by the student are displayed by the beams projected by the beam projector.

14. An electronic class system comprising:
a student electronic pen which generates and transmits student writing data by recognizing a dot pattern at the points where the student electronic pen comes into contact with a dot book printed with the dot pattern according to student writing on the dot book;
a computer which receives and outputs the student writing data through a beam projector interface;
a beam projector which receives the student writing data outputted through the beam projector interface, and projects the student writing data as beams; and
a smart board, on which the contents written by the student are displayed by the beams projected by the beam projector.
